(19) United States
(12) Patent Application Publication
(10) Pub. No.: US 2019/0315644 A1
(43) Pub. Date: Oct. 17, 2019

(54) CONTINOUS ION EXCHANGE RADIUM COMPLEXING

(71) Applicant: Inventure Renewables, Inc., Tuscaloosa, AL (US)

(72) Inventors: William Rusty SUTTERLIN, Tuscaloosa, AL (US); Christopher CHECK, Tuscaloosa, AL (US); William W. BERRY, Tuscaloosa, AL (US)

(21) Appl. No.: 16/384,734

(22) Filed: Apr. 15, 2019

Related U.S. Application Data
(60) Provisional application No. 62/658,292, filed on Apr. 16, 2018.

(51) Int. Cl. C02F 9/00; G21F 9/12

(52) U.S. Cl. CPC C02F 9/00; C02F 1/42; G21F 9/12

(57) ABSTRACT

In alternative embodiments, provided are methods and industrial processes for treating radium-containing oil well flow-back to produce a completely or substantially radium-free water stream product. In alternative embodiments, provided are methods and industrial processes comprising contacting an oil well flow-back with an ion exchange compound to completely or substantially remove radium from the effluent water stream, thereby producing a completely or substantially radium-free effluent, or product. In alternative embodiments, methods provided herein remove the radium present in radium-containing fluids, and the resultant effluents can be removed and stabilized. In alternative embodiments, methods and systems are provided herein are applicable to the treatment of effluents from the hydraulic fracturing of oil and gas formations.

### RELATED APPLICATIONS

This U.S. Utility Patent Application claims the benefit of priority under 35 U.S.C. § 119(e) of U.S. Provisional Application Ser. No. 62/658,292, filed Apr. 16, 2018. The aforementioned application is expressly incorporated herein by reference in its entirety and for all purposes.

### FIELD OF THE INVENTION

This invention generally relates to chemical engineering. More particularly, in alternative embodiments, provided are methods and industrial processes for treating radium-containing oil well flow-back to produce a completely or substantially radium-free water stream product. In alternative embodiments, provided are methods and industrial processes comprising contacting an oil well flow-back with an ion exchange compound to completely or substantially remove radium from the effluent water stream, thereby producing a completely or substantially radium-free effluent, or product. In alternative embodiments, methods provided herein remove the radium present in radium-containing fluids, and the resultant effluents can be removed and stabilized. In alternative embodiments, methods and systems are provided herein are applicable to the treatment of effluents from the hydraulic fracturing of oil and gas formations.

### BACKGROUND

The contribution to the U.S. energy supply from unconventional shale oil and gas sources is growing dramatically. Water is used extensively in shale gas production. A typical well consumes 4-5 million gallons of water during the drilling and hydraulic fracturing processes. Typically this water is trucked in from remote locations. In addition, after the hydrofracturing process, much of this water is returned to the surface as a brine solution termed “frac flowback water” and about 20-50% of the water used to hydrofracture a well is returned as flowback, usually within 2-3 weeks of injection. The frac flowback water is stored in suitable containment tanks before being transported to appropriate treatment or disposal facilities. The flowback water is followed by “produced water” which accumulates over time in well site storage containments. Both frac flowback and produced water from well site storage containments will be referred to as “frac” water.

The frac water has very high salinity (50,000-200,000 ppm TDS, or Total Dissolved Solids), it cannot be disposed of in surface waters. Frac water is frequently disposed of in salt-water disposal wells, which are deep injection wells in salt formations. A significant problem with many of the shale gas plays, including the Marcellus Shale, is that there are few available deep well injection sites and the frac water must be trucked at significant expenses to for example Ohio for deep well injection. Further, environmental regulations prohibit direct, untreated discharge to rivers and other surface waters due to the high salinity and the presence of Naturally Occurring Radioactive Material (NORM), including radium. In other shale gas plays, such as the Barnett Shale in Texas, water availability is limited and the use of large quantities of water for gas production generates substantial resistance from the public.

Stationary regional water processing/recycling or semi-mobile regional processing/recycling of the frac water is desired as a means of reducing the cost of water use and disposal from hydraulic fracturing of oil and gas formations. The very high salinity of the frac water makes conventional treatment problematic as complete or partial precipitation of the TDS is sometimes required to remove materials such as iron species from the frac water before recycling for further use in hydraulic fracturing. In addition, if the frac water treatment is intended for surface water discharge, then the toxic and radioactive materials must be removed, which requires extensive treatment usually requiring complete or significant TDS precipitation, which generates a radium contaminated sludge. This Frac water recycling for re-use or for surface discharge currently creates enormous quantities of sludge which can be contaminated with radium requiring LLRW (low Level Radioactive Waste) landfill disposal for the entire quantity of sludge due to the low radium disposal threshold.

Conventional treatment methods for radium removal include direct contacting with ion exchange compounds in fixed bed or batch mixer and settler configurations which allow for either limited contact time between the compound and the radium containing water or are not optimized and fully exhaust the radium complexing material. Therefore, technology that enables cost effective and substantial removal of the radium by continuous ion exchange which allows for both maximizing contact time and optimizing compound load efficiency is essential for sustained development of this resource.

The cost for sludge disposal as nonhazardous waste in a RCRA-D landfill is typically about $50/ton. However, to qualify for disposal as nonhazardous waste, the sludge must have an activity below a value of 5 to 50 pCi/gm (varies by state). The maximum activity for nonhazardous waste disposal in Pennsylvania is 25 pCi/gm. Sludge that exceeds this value needs to be disposed of as low-level radioactive waste (LLRW), which is discussed below. If the radium activity exceeds about 400 pCi/L, the sludge will need to be either blended with sufficient nonradioactive solid waste to meet the RCRA-D specification or treated as low-level radioactive waste (LLRW). Therefore, there is a great need to have a radium removal technology that minimizes the co-precipitation sludge generation and substantially removes the radium, thereby concentrating the radium containing sludge and minimizing the overall sludge disposal costs.

### SUMMARY OF THE INVENTION

In alternative embodiments, provided are methods and industrial processes for the removal of radium or radium ions and minor element components from a frac water or a primary frac water solution which comprises radium or radium ions, and optionally also comprises a minor element component, wherein a minor element component comprises any of barium, iron, aluminum and magnesium, the method or process comprising use of a calcium sulfate ion exchange compound in combination with, or in conjunction with, a Continuous Ion Exchange (CIX) system or continuous liquid solid contacting system.

In alternative embodiments, of methods and industrial processes as provided herein:
a cation compound is used to remove the radium or radium ions from the frac water and load the radium ions onto a strong cation ion exchange compound, wherein optionally the strong cation exchange compound comprises a sulfate or a sulfite form to conduct the removal step;
the primary frac water solution is contacted with a first ion exchange compound comprising a complexing compound with affinity for radium or radium ions from a frac water media, thereby producing a secondary frac water solution;
the secondary frac water solution is contacted with a second ion exchange compound comprising a complexing compound with affinity for radium or radium ions from a frac water media, thereby producing a tertiary frac water solution; and/or
the tertiary frac water solution is contacted with a third ion exchange compound comprising a complexing compound with affinity for radium or radium ions from a frac water media, thereby producing a quaternary frac water solution.

In alternative embodiments, provided are methods and industrial processes for removing a radium radioactive material from water or an aqueous solution, the method comprising: (a) contacting a radium containing water or an aqueous solution, optionally a frac water, with a solid ion exchange compound comprising a calcium sulfate, a calcium sulfite or a mixture thereof, thereby producing a radium sulfate, radium sulfite or a combination thereof within the solid ion exchange compound; and, (b) separating the treated water or aqueous solution from the solid ion exchange compound and the radium-exchanged radium sulfate, radium sulfite or a combination thereof.

In alternative embodiments, of methods and industrial processes as provided herein: the calcium sulfate is in a powder form; or the calcium sulfate is in a granular form; or the calcium sulfate ion exchange compound is used in combination with, or in conjunction with, a Continuous Ion Exchange (CIX) system or continuous liquid solid contacting system.

In alternative embodiments, provided are methods and industrial processes for removing barium and a naturally occurring radioactive material from water or an aqueous solution, the method comprising: (a) treating the water or aqueous solution by adding a mixture comprising a substantially calcium sulfate and calcium sulfite source to form a suspension of barium sulfite, radium sulfite, barium sulfate, radium sulfate or a combination thereof; and, (b) separating the treated water or aqueous solution from the barium sulfite, radium sulfite, barium sulfate, radium sulfate or combination thereof.

In alternative embodiments, of methods and industrial processes as provided herein:
the sulfite and/or sulfate source is in a powder form; or, the sulfite and/or sulfate source is in a granular form;
the separation of the substantially barium and radium sulfite salt and barium and radium sulfate salt is done by gravity or centrifugation, optionally by use of a hydrocyclone;
the separation of the substantially barium and radium sulfite salt and barium and radium sulfate salt is done by a filtration or by cyclonic separation, wherein optionally the filtration system comprises a leaf filter, a filter press, a membrane filter, a canister filter or a sock filter;
the calcium sulfate ion exchange compound is used in combination with, or in conjunction with, a Continuous Ion Exchange (CIX) system or continuous liquid solid contacting system;
the method or process is carried out under conditions comprising between about pH 7 and 8, between about pH 6 and pH 9, between about pH 5 and pH 10, or between about pH 4 and pH 11; and optionally the method or process is carried out under conditions comprising about ambient temperature, or between about 30 and 40 degrees centigrade;
the Continuous Ion Exchange (CIX) system or the continuous liquid solid contacting system comprises any one or several of:
Agarose, 4% cross-linked, hardened (e.g., an SP Cellthru BigBead Plus™ (Sterogene, Carlsbad, Calif.)),
Agarose, 6% cross-inked, quartz core (e.g., a Streamline SP™ (GE Healthcare Life Sciences)),
Agarose, 6% cross-linked, quartz core, dextran surface extender (e.g., a Streamline SP XL™ (GE Healthcare Life Sciences)),
Agarose, 6% cross-linked (e.g., SP Sepharose Big Beads™ (GE Healthcare Life Sciences)),
Methacrylic polymer (e.g., a Toyopearl M-Cap II SP-550EC™ (Tosoh Bioscience, King of Prussia, Pa.)),
Dextran, cross-linked (e.g., an SP Sephadex A-25™ (GE Healthcare Life Sciences)),
Methacrylic polymer (e.g., a Toyopearl SP-550C™) (Tosoh Bioscience, King of Prussia, Pa.)),
Methacrylic polymer (e.g., a Toyopearl SP-650C™) (Tosoh Bioscience, King of Prussia, Pa.)),
Agarose, 6% crosslinked (e.g., a SP Sepharose Fast Flow™ (GE Healthcare Life Sciences)),
Agarose, 6% cross-linked, dextran surface extender (e.g., a SP Sepharose XL™ (GE Healthcare Life Sciences)),
Cellulose, cross-linked, dextran surface extender (e.g., a Cellufine MAX 5-r™ (JNC Corporation, JP),
Acrylamide/vinyl copolymer, proprietary surface extender (e.g., a Nuvia S™ (BioRAD),
Vinyl ether polymer, proprietary surface extender (e.g., a Eshmuno S Resin™ (Millipore),
Acrylamide/vinyl copolymer (e.g., a UNOsphere S™ (BioRAD),
Methacrylic polymer (e.g., a Toyopearl Giga-Cap S-650 (M)™) (Tosoh Bioscience, King of Prussia, Pa.)),
Acrylamide-dextran copolymer (e.g., a MacroCap SP™ (GE Healthcare Life Sciences)),
Methacrylic polymer (e.g., a Toyopearl SP-650S™ (Tosoh Bioscience, King of Prussia, Pa.)), and/or
Methacrylic polymer (e.g., a TSKgel SP-3PW™ (Tosoh Bioscience, King of Prussia, Pa.)).

The details of one or more embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### DESCRIPTION OF DRAWINGS

The drawings set forth herein are illustrative of exemplary embodiments provided herein and are not meant to limit the scope of the invention as encompassed by the claims.

FIGURES are described in detail herein.

FIG. 1 schematically illustrates an exemplary frac water treatment process as provided herein, and described in further detail, below.

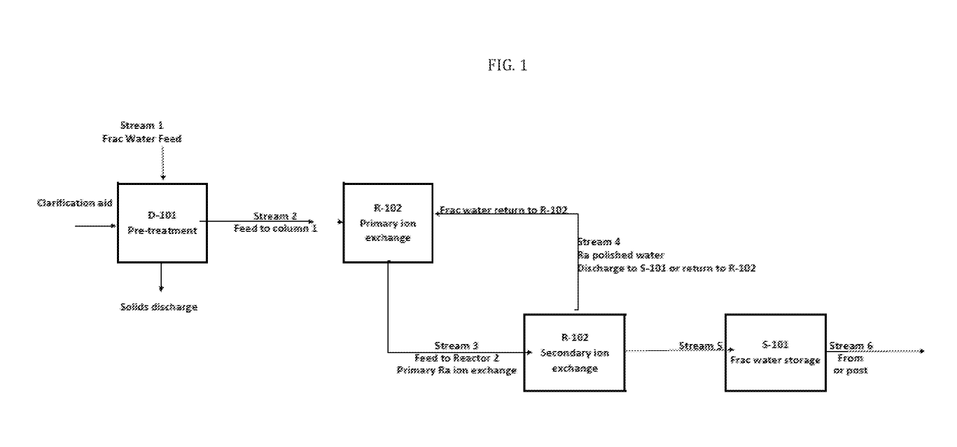

Like reference symbols in the various drawings indicate like elements.

### DETAILED DESCRIPTION

In alternative embodiments, provided are methods and industrial processes that process frac water (“frac water” comprises both frac flowback water (water returned to the surface after a hydrofracturing process) and produced water from well site storage containments) to substantially remove any radium in the frac water; where in one embodiment, removal of a substantial amount of contaminating radium allows the frac water to be further processed for re-use without the expense of needing to use a LLRW (low Level Radioactive Waste) landfill for the entirety of sludge generated. In alternative embodiments, methods and systems as provided herein can substantially concentrate the radium in the frac water, or substantially remove any radium in the frac water, by use of an ion exchange compound, or a continuous ion exchange (CIX) system or continuous liquid-solid contacting system, as provided herein.

In alternative embodiments, provided are methods and systems comprising use of an ion exchange approach which uses a solid contacting media such as an ion exchange compound to extract the radium (Ra) from the frac water. In alternative embodiments, a modified continuous ion exchange contacting system is used, this allows for an effective process extraction and treatment methodology when compared to non-continuous systems.

For the ion exchange recovery embodiments, commercially manufactured solid ion exchange compounds can be used to exchange the Ra contained in the frac water for a “counter-ion” that is loaded on the ion exchange compound; and different ion exchange compounds can be used to match the particular chemistry required for the particular system.

In alternative embodiments, for the radium recovery system from frac water, a specific compound is used that would allow for Ra extraction from the frac water and then simple disposal of the radium loaded compound. Specialized compounds are used for this purpose, and the extent of compounds available for unique applications has increased considerably over the past 15 to 20 years. This advancement in ion exchange compound availability has also been spurred by the development and availability of continuous contacting systems that allow for more efficient contacting and operability.

In alternative embodiments of the treatment of frac water, the first step in the treatment is removal of grease and solids material prior to chemical treatment. In alternative embodiments, a sulfate precipitation step is used where alkaline earth ions (for example, Ba, Sr and Ca), if present, are removed en masse as insoluble sulfate compounds. Unfortunately, since RaSO₄ is more insoluble than BaSO₄, the Ra will crystallize with the other sulfates and result in potential contamination of the alkaline-SO₄ mixed precipitate. Work has been conducted in the past with the use of a BaSO₄ impregnated ion exchange compound for Ra removal (for example DOWEX RSC™) from frac water that had relatively low levels of competing alkali or alkaline cations. These BaSO₄ impregnated compounds show poor results for radium removal when frac waters with the high salt concentrations in the frac water are present. In order to overcome this high salt factor, methods and systems as provided herein use an alkaline sulfate or sulfite, such as a CaSO₄ and/or a CaSO₃ compound, whereby the water is continuously contacted with the ion exchange compound to fully exchange the radium from the water.

In alternative embodiments, methods and systems as provided herein address problems observed in some industrial cases, for example, large scale wet-process phos-frac water production, where it has been observed that the naturally occurring Ra in the phosphate rock substitutes into the CaSO₄ crystal during reaction of phosphate rock with sulfuric frac water to form phos-frac water and CaSO₄. Because the CaSO₄ has limited solubility, but greater solubility than BaSO₄ and RaSO₄ (with RaSO₄ being the most insoluble of the salts), methods and systems as provided herein use ion exchange Ca₂₊ for Ra⁺ and Ba²⁺ ions.

In alternative embodiments, methods and systems as provided herein comprise use of a radium ion exchange comprising a cation exchange, where radium has been exchanged with calcium (with RaSO₄ being the most insoluble of the salts). The sulfate ion exchange with radium is as shown below:

RaX2(aq)+CaSO4(aq)=RaSO4(s)+CaX2(aq)

or

RaX(aq)+CaSO4(aq)=RaSO4(s)+CaX

The ion exchange compound has limited solubility in water 4.93×10⁻⁵. This limited solubility provides for limited ionic species donation of SO₄(2⁻) and Ca²⁺. The ion donation of SO₄(2⁻) reacts with ionic Ra⁺ to form the least soluble salt RaSO₄3.66×10⁻¹¹. The Ca²⁺ ion species donation reacts with X- or X2- to form soluble CaX2 or CaX. The SO₄(2⁻) ionic species also reacts with Ba²⁺ ions in the frac water however the solubility of BaSO₄ is higher 1.08×10⁻¹⁰ and there is a potential for the SO₄(2⁻) to remain ionic or re-enter its ionic state and form the less soluble RaSO₄ salt. The insoluble radium sulfate solid remains in the stationary phase of the continuous ion exchange system and is removed from the solution. As was observed in large scale wet-process phos-frac water production, the naturally occurring Ra in the phosphate rock substitutes into the CaSO₄ crystal which in the present invention is the stationary phase in the continuous ion exchange system. Therefore, the radium ion exchange compound in combination with the continuous ion exchange system could be a valuable tool to effectively and continuously remove radium from frac waters before re-use or recycling.

### Frac Water Pretreatment:

In alternative embodiments, methods and systems as provided herein comprise use of a frac water preparation for the ion exchange approach comprising reducing the suspended solids in a feed frac water to a specific target level; in alternative embodiments, some level of solids is tolerable in the continuous contacting system.

In alternative embodiments, the incoming frac water is cooled, and then optionally treated with a clarification aid for suspended solids removal followed by clarification. The solids from this step can be sent to disposal.

In alternative embodiments, a difference between the Ion Exchange processes as provided herein and previous solvent extraction methodologies is that in Ion Exchange processes as provided herein a solid, functionalized material (for example, ion Exchange compounds) is used to extract the Ra from the frac water media.

### Primary Ion Exchange Extraction

In alternative embodiments, the clarified pretreated frac water enters a Primary Continuous Contacting System, where it is contacted in a continuous unit with the chosen ion exchange compound. In the Ion Exchange contacting system the frac water passes through and in contact with the ion exchange compound where the contained radium (soluble) is transferred from the frac water to the compound matrix itself via a specific ion exchange mechanism, for example, ion exchanging Ca²⁺ for Ra²⁺ and Ba²⁺ ions. The low radium frac water is then sent to storage, re-use or disposal.

In alternative embodiments of exemplary ion exchange as provided herein, there is no need for additional post treatment since the extraction media (or extraction compound) has very limited solubility in the frac water. The radium contained in the Ion Exchange compound is bound in the compound matrix.

### Secondary Ion Exchange Extraction Systems

In alternative embodiments, methods and systems as provided herein comprise use of a secondary extraction system, where the frac water solution is contacted in a secondary ion exchange system. The system is considerably smaller than the primary circuit. The Ra not removed in the primary circuit regeneration system is contacted in the secondary ion exchange system to complete the ion exchange of radium into a compound crystal matrix.

In alternative embodiments, the effluent, or “lean solution”, from the secondary Ion Exchange system, is recycled to the maximum extent possible till the radium content is fully depleted or very substantially depleted, e.g., 97%, 98% or 99% or more depleted. In alternative embodiments, the radium depleted frac water is then taken to further treatment, containment or disposal.

### Ion Exchange Compound

The compound has limited solubility in water 4.93×10⁻⁵. This limited solubility provides for limited ionic species donation of SO₄(2⁻) and Ca²⁺. The ion donation of SO₄(2⁻) reacts with ionic Ra2+ to form the least soluble salt RaSO₄ 3.66×10⁻¹¹. The Ca²⁺ ion species donation reacts with the anion (X- or X2-) to form soluble CaX2 or CaX. The SO₄(2⁻) ionic species also reacts with Ba²⁺ ions in the frac water; however, the solubility of BaSO₄ is higher 1.08×10⁻¹⁰ and there is a potential for the SO₄(2⁻) to remain ionic and form the least soluble RaSO₄ salt. The insoluble radium sulfate precipitates, becomes trapped in the Ion Exchange crystal matrix of the solid material or is removed from the solution. The below table shows an example of species solubility constants.

| Compound | Formula | Kₛₚ (25° C.) |
|---|---|---|
| Aluminium hydroxide | Al(OH)₃ | 3 × 10⁻³⁴ |
| Aluminium phosphate | AlPO₄ | 9.84 × 10⁻²¹ |
| Barium bromate | Ba(BrO₃)₂ | 2.43 × 10⁻⁴ |
| Barium carbonate | BaCO₃ | 2.58 × 10⁻⁹ |
| Barium chromate | BaCrO₄ | 1.17 × 10⁻¹⁰ |
| Barium fluoride | BaF₂ | 1.84 × 10⁻⁷ |
| Barium hydroxide octahydrate | Ba(OH)₂ × 8H₂O | 2.55 × 10⁻⁴ |
| Barium iodate | Ba(IO₃)₂ | 4.01 × 10⁻⁹ |
| Barium iodate monohydrate | Ba(IO₃)₂ × H₂O | 1.67 × 10⁻⁹ |
| Barium molybdate | BaMoO₄ | 3.54 × 10⁻⁸ |
| Barium nitrate | Ba(NO₃)₂ | 4.64 × 10⁻³ |
| Barium selenate | BaSeO₄ | 3.40 × 10⁻⁸ |
| Barium sulfate | BaSO₄ | 1.08 × 10⁻¹⁰ |
| Barium sulfite | BaSO₃ | 5.0 × 10⁻¹⁰ |
| Beryllium hydroxide | Be(OH)₂ | 6.92 × 10⁻²² |
| Bismuth arsenate | BiAsO₄ | 4.43 × 10⁻¹⁰ |
| Bismuth iodide | BiI | 7.71 × 10⁻¹⁹ |
| Cadmium arsenate | Cd₃(AsO₄)₂ | 2.2 × 10⁻³³ |
| Cadmium carbonate | CdCO₃ | 1.0 × 10⁻¹² |
| Cadmium fluoride | CdF₂ | 6.44 × 10⁻³ |
| Cadmium hydroxide | Cd(OH)₂ | 7.2 × 10⁻¹⁵ |
| Cadmium iodate | Cd(IO₃)₂ | 2.5 × 10⁻⁸ |
| Cadmium oxalate trihydrate | CdC₂O₄ × 3H₂O | 1.42 × 10⁻⁸ |
| Cadmium phosphate | Cd₃(PO₄)₂ | 2.53 × 10⁻³³ |
| Cadmium sulfide | CdS | 1 × 10⁻²⁷ |
| Caesium perchlorate | CsClO₄ | 3.95 × 10⁻³ |
| Caesium periodate | CsIO₄ | 5.16 × 10⁻⁶ |
| Calcium carbonate (calcite) | CaCO₃ | 3.36 × 10⁻⁹ |
| Calcium carbonate (aragonite) | CaCO₃ | 6.0 × 10⁻⁹ |
| Calcium fluoride | CaF₂ | 3.45 × 10⁻¹¹ |
| Calcium hydroxide | Ca(OH)₂ | 5.02 × 10⁻⁶ |
| Calcium iodate | Ca(IO₃)₂ | 6.47 × 10⁻⁶ |
| Calcium iodate hexahydrate | Ca(IO₃)₂ × 6H₂O | 7.10 × 10⁻⁷ |
| Calcium molybdate | CaMoO | 1.46 × 10⁻⁸ |
| Calcium oxalate monohydrate | CaC₂O₄ × H₂O | 2.32 × 10⁻⁹ |
| Calcium phosphate | Ca₃(PO₄)₂ | 2.07 × 10⁻³³ |
| Calcium sulfate | CaSO₄ | 4.93 × 10⁻⁵ |
| Calcium sulfate dihydrate | CaSO₄ × 2H₂O | 3.14 × 10⁻⁵ |
| Calcium sulfate hemihydrate | CaSO₄ × 0.5H₂O | 3.l × 10⁻⁷ |
| Cobalt(II) arsenate | Co₃(AsO₄)₂ | 6.80 × 10⁻²⁹ |
| Cobalt(II) carbonate | CoCO₃ | 1.0 × 10⁻¹⁰ |
| Cobalt(II) hydroxide (blue) | Co(OH)₂ | 5.92 × 10⁻¹⁵ |
| Cobalt(II) iodate dihydrate | Co(IO₃)₂ × 2H₂O | 1.21 × 10⁻² |
| Cobalt(II) phosphate | Co₃(PO₄)₂ | 2.05 × 10⁻³⁵ |
| Cobalt(II) sulfide (alpha) | CoS | 5 × 10⁻²² |
| Cobalt(II) sulfide (beta) | CoS | 3 × 10⁻²⁶ |
| Copper(I) bromide | CuBr | 6.27 × 10⁻⁹ |
| Copper(I) chloride | CuCl | 1.72 × 10⁻⁷ |
| Copper(I) cyanide | CuCN | 3.47 × 10⁻²⁰ |
| Copper(I) hydroxide * | Cu₂O | 2 × 10⁻¹⁵ |
| Copper(I) iodide | CuI | 1.27 × 10⁻¹² |
| Copper(I) thiocyanate | CuSCN | 1.77 × 10⁻¹³ |
| Copper(II) arsenate | Cu₃(AsO₄)₂ | 7.95 × 10⁻³⁶ |
| Copper(II) hydroxide | Cu(OH)₂ | 4.8 × 10⁻²⁰ |
| Copper(II) iodate monohydrate | Cu(IO₃)₂ × H₂O | 6.94 × 10⁻⁸ |
| Copper(II) oxalate | CuC₂O₄ | 4.43 × 10⁻¹⁰ |
| Copper(II) phosphate | Cu₃(PO₄)₂ | 1.40 × 10⁻³⁷ |
| Copper(II) sulfide | CuS | 8 × 10⁻³⁷ |
| Europium(III) hydroxide | Eu(OH)₃ | 9.38 × 10⁻²⁷ |
| Gallium(III) hydroxide | Ga(OH)₃ | 7.28 × 10⁻³⁶ |
| Iron(II) carbonate | FeCO₃ | 3.13 × 10⁻¹¹ |
| Iron(II) fluoride | FeF₂ | 2.36 × 10⁻⁶ |
| Iron(II) hydroxide | Fe(OH)₂ | 4.87 × 10⁻¹⁷ |
| Iron(II) sulfide | FeS | 8 × 10⁻¹⁹ |
| Iron(III) hydroxide | Fe(OH)₃ | 2.79 × 10⁻³⁹ |
| Iron(III) phosphate dihydrate | FePO₄ × 2H₂O | 9.91 × 10⁻¹⁶ |
| Lanthanum iodate | La(IO₃)₃ | 7.50 × 10⁻¹² |
| Lead(II) bromide | PbBr₂ | 6.60 × 10⁻⁶ |
| Lead(II) carbonate | PbCO₃ | 7.40 × 10⁻¹⁴ |
| Lead(II) chloride | PbCl₂ | 1.70 × 10⁻⁵ |
| Lead(II) chromate | PbCrO₄ | 3 × 10⁻¹³ |
| Lead(II) fluoride | PbF₂ | 3.3 × 10⁻⁸ |
| Lead(II) hydroxide | Pb(OH)₂ | 1.43 × 10⁻²⁰ |
| Lead(II) iodate | Pb(IO₃)₂ | 3.69 × 10⁻¹³ |
| Lead(II) iodide | PbI₂ | 9.8 × 10⁻⁹ |
| Lead(II) oxalate | PbC₂O₄ | 8.5 × 10⁻⁹ |
| Lead(II) selenate | PbSeO₄ | 1.37 × 10⁻⁷ |
| Lead(II) sulfate | PbSO₄ | 2.53 × 10⁻⁸ |
| Lead(II) sulfide | PbS | 3 × 10⁻²⁸ |
| Lithium carbonate | Li₂CO₃ | 8.15 × 10⁻⁴ |
| Lithium fluoride | LiF | 1.84 × 10⁻³ |
| Lithium phosphate | Li₃PO₄ | 2.37 × 10⁻⁴ |
| Magnesium ammonium phosphate | MgNH₄PO₄ | 3 × 10⁻¹³ |
| Magnesium carbonate | MgCO₃ | 6.82 × 10⁻⁶ |
| Magnesium carbonate trihydrate | MgCO₃ × 3H₂O | 2.38 × 10⁻⁶ |
| Magnesium carbonate pentahydrate | MgCO₃ × 5H₂O | 3.79 × 10⁻⁶ |
| Magnesium fluoride | MgF₂ | 5.16 × 10⁻¹¹ |
| Magnesium hydroxide | Mg(OH)₂ | 5.61 × 10⁻¹² |
| Magnesium oxalate dihydrate | MgC₂O₄ × 2H₂O | 4.83 × 10⁻⁶ |
| Magnesium phosphate | Mg₃(PO₄)₂ | 1.04 × 10⁻²⁴ |
| Manganese(II) carbonate | MnCO₃ | 2.24 × 10⁻¹¹ |
| Manganese(II) iodate | Mn(IO₃)₂ | 4.37 × 10⁻⁷ |
| Manganese(II) hydroxide | Mn(OH)₂ | 2 × 10⁻¹³ |
| Manganese(II) oxalate dihydrate | MnC₂O₄ × 2H₂O | 1.70 × 10⁻¹⁷ |
| Manganese(II) sulfide (pink) | MnS | 3 × 10⁻¹¹ |
| Manganese(II) sulfide (green) | MnS | 3 × 10⁻¹⁴ |
| Mercury(I) bromide | Hg₂Br₂ | 6.40 × 10⁻²³ |
| Mercury(I) carbonate | Hg₂CO₃ | 3.6 × 10⁻¹⁷ |
| Mercury(I) chloride | Hg₂Cl₂ | 1.43 × 10⁻¹⁸ |
| Mercury(I) fluoride | Hg₂F₂ | 3.10 × 10⁻⁶ |
| Mercury(I) iodide | Hg₂I₂ | 5.2 × 10⁻²⁹ |
| Mercury(I) oxalate | Hg₂C₂O₄ | 1.75 × 10⁻¹³ |
| Mercury(I) sulfate | Hg₂SO₄ | 6.5 × 10⁻⁷ |
| Mercury(I) thiocyanate | Hg₂(SCN)₂ | 3.2 × 10⁻²⁰ |
| Mercury(II) bromide | HgBr₂ | 6.2 × 10⁻²⁰ |
| Mercury(II) hydroxide ** | HgO | 3.6 × 10⁻²⁶ |
| Mercury(II) iodide | HgI₂ | 2.9 × 10⁻²⁹ |
| Mercury(II) sulfide (black) | HgS | 2 × 10⁻⁵³ |
| Mercury(II) sulfide (red) | HgS | 2 × 10⁻⁵⁴ |
| Neodymium carbonate | Nd₂(CO₃)₃ | 1.08 × 10⁻³³ |
| Nickel(II) carbonate | NiCO₃ | 1.42 × 10⁻⁷ |
| Nickel(II) hydroxide | Ni(OH)₂ | 5.48 × 10⁻¹⁶ |
| Nickel(II) iodate | Ni(IO₃)₂ | 4.71 × 10⁻⁵ |
| Nickel(II) phosphate | Ni₃(PO₄)₂ | 4.74 × 10⁻³² |
| Nickel(II) sulfide (alpha) | NiS | 4 × 10⁻²⁰ |
| Nickel(II) sulfide (beta) | NiS | 1.3 × 10⁻²⁵ |
| Palladium(II) thiocyanate | Pd(SCN)₂ | 4.39 × 10⁻²³ |
| Potassium hexachloroplatinate | K₂PtCl₆ | 7.48 × 10⁻⁶ |
| Potassium perchlorate | KClO₄ | 1.05 × 10⁻² |
| Potassium periodate | KIO₄ | 3.71 × 10⁻⁴ |
| Praseodymium hydroxide | Pr(OH)₃ | 3.39 × 10⁻²⁴ |
| Radium iodate | Ra(IO₃)₂ | 1.16 × 10⁻⁹ |
| Radium sulfate | RaSO₄ | 3.66 × 10⁻¹¹ |
| Rubidium perchlorate | RuClO₄ | 3.00 × 10⁻³ |
| Scandium fluoride | ScF₃ | 5.81 × 10⁻²⁴ |
| Scandium hydroxide | Sc(OH)₃ | 2.22 × 10⁻³¹ |
| Silver(I) acetate | AgCH₃COO | 1.94 × 10⁻³ |
| Silver(I) arsenate | Ag₃AsO₄ | 1.03 × 10⁻²² |
| Silver(I) bromate | AgBrO₃ | 5.38 × 10⁻⁵ |
| Silver(I) bromide | AgBr | 5.35 × 10⁻¹³ |
| Silver(I) carbonate | Ag₂CO₃ | 8.46 × 10⁻¹² |
| Silver(I) chloride | AgCl | 1.77 × 10⁻¹⁰ |
| Silver(I) chromate | Ag₂CrO₄ | 1.12 × 10⁻¹² |
| Silver(I) cyanide | AgCN | 5.97 × 10⁻¹⁷ |
| Silver(I) iodate | AgIO₃ | 3.17 × 10⁻⁸ |
| Silver(I) iodide | AgI | 8.52 × 10⁻¹⁷ |
| Silver(I) oxalate | Ag₂C₂O₄ | 5.40 × 10⁻¹² |
| Silver(I) phosphate | Ag₃PO₄ | 8.89 × 10⁻¹⁷ |
| Silver(I) sulfate | Ag₂SO₄ | 1.20 × 10⁻⁵ |
| Silver(I) sulfite | Ag₂SO₃ | 1.50 × 10⁻¹⁴ |
| Silver(I) sulfide | Ag₂S | 8 × 10⁻⁵¹ |
| Silver(I) thiocyanate | AgSCN | 1.03 × 10⁻¹² |
| Strontium arsenate | Sr₃(AsO₄)₂ | 4.29 × 10⁻¹⁹ |
| Strontium carbonate | SrCO₃ | 5.60 × 10⁻¹⁰ |
| Strontium fluoride | SrF₂ | 4.33 × 10⁻⁹ |
| Strontium iodate | Sr(IO₃)₂ | 1.14 × 10⁻⁷ |
| Strontium iodate monohydrate | Sr(IO₃)₂ × H₂O | 3.77 × 10⁻⁷ |
| Strontium iodate hexahydrate | Sr(IO₃)₂ × 6H₂O | 4.55 × 10⁻⁷ |
| Strontium oxalate | SrC₂O₄ | 5 × 10⁻⁸ |
| Strontium sulfate | SrSO₄ | 3.44 × 10⁻⁷ |
| Thallium(I) bromate | TlBrO₃ | 1.10 × 10⁻⁴ |
| Thallium(I) bromide | TlBr | 3.71 × 10⁻⁶ |
| Thallium(I) chloride | TlCl | 1.86 × 10⁻⁴ |
| Thallium(I) chromate | Tl₂CrO₄ | 8.67 × 10⁻¹³ |
| Thallium(I) hydroxide | Tl(OH)₃ | 1.68 × 10⁻⁴⁴ |
| Thallium(I) iodate | TlIO₃ | 3.12 × 10⁻⁶ |
| Thallium(I) iodide | TlI | 5.54 × 10⁻⁸ |
| Thallium(I) thiocyanate | TlSCN | 1.57 × 10⁻⁴ |
| Thallium(I) sulfide | Tl₂S | 6 × 10⁻²² |
| Tin(II) hydroxide | Sn(OH)₂ | 5.45 × 10⁻²⁷ |
| Yttrium carbonate | Y₂(CO₃)₃ | 1.03 × 10⁻³¹ |
| Yttrium fluoride | YF₃ | 8.62 × 10⁻²¹ |
| Yttrium hydroxide | Y(OH)₃ | 1.00 × 10⁻²² |
| Yttrium iodate | Y(IO₃)₃ | 1.12 × 10⁻¹⁰ |
| Zinc arsenate | Zn₃(AsO₄)₂ | 2.8 × 10⁻²⁸ |
| Zinc carbonate | ZnCO₃ | 1.46 × 10⁻¹⁰ |
| Zinc carbonate monohydrate | ZnCO₃ × H₂O | 5.42 × 10⁻¹¹ |
| Zinc fluoride | ZnF | 3.04 × 10⁻² |
| Zinc hydroxide | Zn(OH)₂ | 3 × 10⁻¹⁷ |
| Zinc iodate dihydrate | Zn(IO₃)₂ × 2H₂O | 4.1 ×10⁻⁶ |
| Zinc oxalate dihydrate | ZnC₂O₄ × 2H₂O | 1.38 × 10⁻⁹ |
| Zinc selenide | ZnSe | 3.6 × 10⁻²⁶ |
| Zinc selenite monohydrate | ZnSe × H₂O | 1.59 × 10⁻⁷ |
| Zinc sulfide (alpha) | ZnS | 2 × 10⁻²⁵ |
| Zinc sulfide (beta) | ZnS | 3 × 10⁻²³ |

The below table show the solubility of select soluble compounds

Calcium chloride Dihydrate:
134.5 g/100 mL (60° C.)
152.4 g/100 mL (100° C.)
Iron chloride Monohydrate:
44.69 g/100 mL (77° C.)
35.97 g/100 mL (90.1° C.)
Iron sulfate:
912 g/L(25° C.)

For example, in a demonstration study, 5 samples of radium containing frac water were tested for Ra content before treatment by Pace Analytical Services, LLC. The 5 samples were 9,075.3 pCi/L, 8,324.2 pCi/L, 4,063.4 pCi/L, 3,993.7 pCi/L and 4,649.0 PiC/L. After treatment with InvenSorb RST™ CaSO₄ provided by Inventure Renewables (Tuscaloosa, Ala.) the sample results were 0.000 pCi/L, 73.368 pCi/L, 0.000 pCi/L, 0.000 pCi/L and 0.000 pCi/L. InvenSorb RST™ primarily comprises a mixture of alkali sulfate and alkali sulfite salts comprising calcium sulfate, calcium sulfite, calcium carbonate, silica, magnesium oxide, calcium oxide and calcium hydroxide.

In alternative embodiments, as a first step, the raw frac water is first treated for grease, oil and solids removal. Optionally, the frac water that contains iron and manganese is treated with lime and air to oxidize Fe⁺² and Mn⁺² to Fe⁺³ and Mn⁺⁴, respectively.

In alternative embodiments, in a second step, iron and manganese as well as suspended solids are precipitated in a clarifier. If iron or manganese is present, the oxidation and precipitation steps may be omitted.

In alternative embodiments, the raw frac water is first treated for grease, oil and solids removal. The frac water is then directly contacted with CaSO₄, CaSO₃ or a combination of CaSO₄ and CaSO₃ to form insoluble radium sulfate and or radium sulfite and other salts. In alternative embodiments, the resulting treated frac water is then sent to a further treatment comprising steps to remove iron and manganese, which are typically treated with lime and air to oxidize Fe⁺² and Mn⁺² to Fe⁺³ and Mn⁺⁴, respectively, as well as suspended solids, which are precipitated in a clarifier.

In alternative embodiments, the pre-treated frac water is then contacted with the ion exchange compound in a liquid/solid contacting circuit. The frac water liquid is passed through a column loaded with the ion exchange compound. The dissolved radium species exchanges with the sulfate and sulfite contained in the ion exchange compound and forms insoluble species inside the ion exchange crystal matrix. Alternatively, and if required, the radium depleted frac water is then sent to any number of additional contacting columns loaded with ion exchange resin. The limited solubility of the ion exchange compound allows for limited ion species donation to the frac water.

In alternative embodiments, the frac water is further contacted with additional columns loaded with ion exchange columns or the frac water is recycled through the first column until the frac water is fully or very substantially depleted, e.g., 97%, 98% or 99% or more depleted, of radium.

In alternative embodiments, the number of columns and configuration of the continuous contacting cycle is dependent on radium load in the frac water and volume of water to be processed; however, an unlimited number of columns and stationary phase ion exchange compound can be used, and the exact number can be sized to meet the needs of the project.

In alternative embodiments, the frac water stream is filtered before it is contacted with the CaSO₄, CaSO₃ or a combination of CaSO₄ and CaSO₃ compound. Filtration may be omitted if desired or unnecessary because the bulk of the radium is removed from the frac water brine prior to further treatment; the radium level in the downstream sludge is typically acceptable for disposal in a RCRA-D landfill for non-hazardous waste.

In alternative embodiments, the resulting radium sulfate sludge is de-watered in a thickener and filter press. The resulting non-radium containing sludge may also be dewatered in a thickener and filter press. Water from the dewatering process may be recycled to the front of the process. The pretreated frac water brine may then be safely reused as radium-free source water blend stock for hydrofracturing, or may be further purified.

In the alternative embodiments, the pretreated frac water brine is passed through a thermal evaporator or an equivalent, such as a brine concentrator, to preconcentrate the brine. Brine concentration technology is well established and one of skill in art would be able to configure and operate a system for use with frac water brine without difficulty. For example, vertical-tube, falling-film evaporators may be used in this step, such as the RCC® Brine Concentrator™ available from GE Water & Process Technologies. This type of falling film evaporator for treating waters saturated with scaling constituents such as calcium sulfate or silica can be used in processes as provided here.

In an optional step, the preconcentrated brine is passed through a salt crystallizer to recover distilled water and salable NaCl. Any crystallizer for use with concentrated brine may be used, e.g., RCC® Crystallizer systems from GE Water & Process Technologies are suitable, as are mechanical vapor recompression (MVR) technologies to recycle the steam vapor, minimizing energy consumption and costs.

In a final, optional, step, the salt produced in the crystallizer may be washed to yield a compound that may be sold for use as road salt. Even without a wash step, in some cases, the dry crystalline NaCl product may meet government standards for use as road salt, being free of toxic substances as determined by Toxicity Characteristic Leaching Procedure (TCLP) analysis and conforming to the ASTM D-635 standard for road salt. The wash water may be subjected to lime treatment to produce a sludge that may be dried prior to disposal as non-hazardous waste.

The following table describes frac water from a well in western Pennsylvania.

Sample 1.
Frac Water Composition (mg/L except where noted)

| | 1 |
|---|---|
| TDS | 67,400 |
| Na+ | 19,200 |
| Mg++ | 560 |
| Ca++ | 5,360 |
| Sr++ | 1,290 |
| Ba++ | 32 |
| Fe++ | 55 |
| Mn++ | 2 |
| | 12,500 |
| SO4= | <10 |
| 226Ra pCi/liter | 4,596 |

The invention will be further described with reference to the examples described herein; however, it is to be understood that the invention is not limited to such examples.

### EXAMPLES

### Example 1

This Example describes an exemplary process of this invention.

Four 1 Liter samples of frac water from a frac water processor in Pennsylvania (RES Water Inc.) was obtained. The sample had been treated to remove suspended solids. Dissolved Ra species had been reported in the five samples as 9,075.3 pCi/L, 8,324.2 pCi/L, 4,063.4 pCi/L, 3,993.7 pCi/L and 4,649.0 PiC/L. 50 grams of InvenSorb RST™ was added to each 1 L sample.

The compound was allowed to contact with the frac water for 24 hours to allow for Ra species ion exchange.

After mixing period the slurry was filtered and the water fraction was recovered.

The filter cake was washed with 100 ml of DI water. The DI wash water was added to the treated frac water.

The InvenSorb RST™ treated frac water was then sent to Pace Analytical Services for radium testing. The results were the sample results were 0.000 pCi/L, 73.368 pCi/L, 0.000 pCi/L, 0.000 pCi/L and 0.000 pCi/L PiC/1.

A number of embodiments of the invention have been described. Nevertheless, it can be understood that various modifications may be made without departing from the spirit and scope of the invention. Accordingly, other embodiments are within the scope of the following claims.

What is claimed is:

1. A method or process for the removal of radium or radium ions and minor element components from a frac water or a primary frac water solution which comprises radium or radium ions, and optionally also comprises a minor element component, wherein a minor element component comprises any of barium, iron, aluminum and magnesium, the method or process comprising use of a calcium sulfate ion exchange compound in combination with, or in conjunction with, a Continuous Ion Exchange (CIX) system or continuous liquid solid contacting system.

2. The method or process of claim 1, wherein a cation compound is used to remove the radium or radium ions from the frac water and load the radium ions onto a strong cation ion exchange compound, wherein optionally the strong cation exchange compound comprises a sulfate or a sulfite form to conduct the removal step.

3. The method or process of claim 1, wherein the primary frac water solution is contacted with a first ion exchange compound comprising a complexing compound with affinity for radium or radium ions from a frac water media, thereby producing a secondary frac water solution.

4. The method or process of claim 3, wherein the secondary frac water solution is contacted with a second ion exchange compound comprising a complexing compound with affinity for radium or radium ions from a frac water media, thereby producing a tertiary frac water solution.

5. The method or process of claim 4, wherein the tertiary frac water solution is contacted with a third ion exchange compound comprising a complexing compound with affinity for radium or radium ions from a frac water media, thereby producing a quaternary frac water solution.

6. A method or process of claim 1, wherein the Continuous Ion Exchange (CIX) system or the continuous liquid solid contacting system comprises any one or several of:
Agarose, 4% cross-linked, hardened (e.g., an SP Cellthru BigBead Plus™ (Sterogene, Carlsbad, Calif.)),
Agarose, 6% cross-inked, quartz core (e.g., a Streamline SP™ (GE Healthcare Life Sciences)),
Agarose, 6% cross-linked, quartz core, dextran surface extender (e.g., a Streamline SP XL™ (GE Healthcare Life Sciences)),
Agarose, 6% cross-linked (e.g., SP Sepharose Big Beads™ (GE Healthcare Life Sciences)),
Methacrylic polymer (e.g., a Toyopearl M-Cap II SP-550EC™ (Tosoh Bioscience, King of Prussia, Pa.)),
Dextran, cross-linked (e.g., an SP Sephadex A-25™ (GE Healthcare Life Sciences)),
Methacrylic polymer (e.g., a Toyopearl SP-550C™) (Tosoh Bioscience, King of Prussia, Pa.)),
Methacrylic polymer (e.g., a Toyopearl SP-650C™) (Tosoh Bioscience, King of Prussia, Pa.)),
Agarose, 6% crosslinked (e.g., a SP Sepharose Fast Flow™ (GE Healthcare Life Sciences)),
Agarose, 6% cross-linked, dextran surface extender (e.g., a SP Sepharose XL™ (GE Healthcare Life Sciences)),
Cellulose, cross-linked, dextran surface extender (e.g., a Cellufine MAX 5-r™ (JNC Corporation, JP),
Acrylamide/vinyl copolymer, proprietary surface extender (e.g., a Nuvia S™ (BioRAD),
Vinyl ether polymer, proprietary surface extender (e.g., a Eshmuno S Resin™ (Millipore),
Acrylamide/vinyl copolymer (e.g., a UNOsphere S™ (BioRAD),
Methacrylic polymer (e.g., a Toyopearl Giga-Cap S-650 (M)™) (Tosoh Bioscience, King of Prussia, Pa.)),
Acrylamide-dextran copolymer (e.g., a MacroCap SP™ (GE Healthcare Life Sciences)),
Methacrylic polymer (e.g., a Toyopearl SP-650S™ (Tosoh Bioscience, King of Prussia, Pa.)), and/or
Methacrylic polymer (e.g., a TSKgel SP-3PW™ (Tosoh Bioscience, King of Prussia, Pa.)).

7. A method or process for removing a radium radioactive material from water or an aqueous solution, the method comprising:
(a) contacting a radium containing water or an aqueous solution, optionally a frac water, with a solid ion exchange compound comprising a calcium sulfate, a calcium sulfite or a mixture thereof, thereby producing a radium sulfate, radium sulfite or a combination thereof within the solid ion exchange compound; and
(b) separating the treated water or aqueous solution from the solid ion exchange compound and the radium-exchanged radium sulfate, radium sulfite or a combination thereof.

8. The method or process of claim 7, wherein the calcium sulfate is in a powder form.

9. The method or process of claim 7, wherein the calcium sulfate is in a granular form.

10. The method or process of claim 7, wherein the calcium sulfate ion exchange compound is used in combination with, or in conjunction with, a Continuous Ion Exchange (CIX) system or continuous liquid solid contacting system.

11. The method or process of claim 7, wherein the calcium sulfate ion exchange compound is used in combination with, or in conjunction with, a Continuous Ion Exchange (CIX) system or continuous liquid solid contacting system.

12. A method or process for removing barium and a naturally occurring radioactive material from water or an aqueous solution, the method comprising:
(a) treating the water or aqueous solution by adding a mixture comprising a substantially calcium sulfate and calcium sulfite source to form a suspension of barium sulfite, radium sulfite, barium sulfate, radium sulfate or a combination thereof; and
(b) separating the treated water or aqueous solution from the barium sulfite, radium sulfite, barium sulfate, radium sulfate or combination thereof.

13. The method or process of claim 12, wherein the sulfite and/or sulfate source is in a powder form.

14. The method or process of claim 12, wherein the sulfite and/or sulfate source is in a granular form.

15. The method or process of claim 12 wherein the separation of the substantially barium and radium sulfite salt and barium and radium sulfate salt is done by gravity or centrifugation, optionally by use of a hydrocyclone.

16. The method or process of claim 12, wherein the separation of the substantially barium and radium sulfite salt and barium and radium sulfate salt is done by a filtration or by cyclonic separation,
wherein optionally the filtration system comprises a leaf filter, a filter press, a membrane filter, a canister filter or a sock filter.

17. A method or process of claim 12, wherein the method or process is carried out under conditions comprising between about pH 6 and pH 9, between about pH 5 and pH 10, or between about pH 4 and pH 11.

18. A method or process of claim 12, wherein the Continuous Ion Exchange (CIX) system or the continuous liquid solid contacting system comprises any one or several of:
Agarose, 4% cross-linked, hardened (e.g., an SP Cellthru BigBead Plus™ (Sterogene, Carlsbad, Calif.)),
Agarose, 6% cross-inked, quartz core (e.g., a Streamline SP™ (GE Healthcare Life Sciences)),
Agarose, 6% cross-linked, quartz core, dextran surface extender (e.g., a Streamline SP XL™ (GE Healthcare Life Sciences)),
Agarose, 6% cross-linked (e.g., SP Sepharose Big Beads™ (GE Healthcare Life Sciences)),
Methacrylic polymer (e.g., a Toyopearl M-Cap II SP-550EC™ (Tosoh Bioscience, King of Prussia, Pa.)),
Dextran, cross-linked (e.g., an SP Sephadex A-25™ (GE Healthcare Life Sciences)),
Methacrylic polymer (e.g., a Toyopearl SP-550C™) (Tosoh Bioscience, King of Prussia, Pa.)),
Methacrylic polymer (e.g., a Toyopearl SP-650C™) (Tosoh Bioscience, King of Prussia, Pa.)),
Agarose, 6% crosslinked (e.g., a SP Sepharose Fast Flow™ (GE Healthcare Life Sciences)),
Agarose, 6% cross-linked, dextran surface extender (e.g., a SP Sepharose XL™ (GE Healthcare Life Sciences)),
Cellulose, cross-linked, dextran surface extender (e.g., a Cellufine MAX 5-r™ (JNC Corporation, JP),
Acrylamide/vinyl copolymer, proprietary surface extender (e.g., a Nuvia S™ (BioRAD),
Vinyl ether polymer, proprietary surface extender (e.g., a Eshmuno S Resin™ (Millipore),
Acrylamide/vinyl copolymer (e.g., a UNOsphere S™ (BioRAD),
Methacrylic polymer (e.g., a Toyopearl Giga-Cap S-650 (M)™) (Tosoh Bioscience, King of Prussia, Pa.)),
Acrylamide-dextran copolymer (e.g., a MacroCap SP™ (GE Healthcare Life Sciences)),
Methacrylic polymer (e.g., a Toyopearl SP-650S™ (Tosoh Bioscience, King of Prussia, Pa.)), and/or
Methacrylic polymer (e.g., a TSKgel SP-3PW™ (Tosoh Bioscience, King of Prussia, Pa.)).
